(19) United States
(12) Patent Application Publication
(10) Pub. No.: US 2018/0209735 A1
(43) Pub. Date: Jul. 26, 2018

(54) SPORTING EQUIPMENT DRYING RACK

(71) Applicants: Kale James Ponto, Edmonton (CA); Lee Ponto, Edmonton (CA); Darren Ponto, Edmonton (CA)

(72) Inventors: Kale James Ponto, Edmonton (CA); Lee Ponto, Edmonton (CA); Darren Ponto, Edmonton (CA)

(21) Appl. No.: 15/414,986

(22) Filed: Jan. 25, 2017

(51) Int. Cl. F26B 21/00; A47B 81/00; A47B 47/00; A63B 71/00; F26B 9/10

(52) U.S. Cl. CPC F26B 21/006; A47B 81/00; F26B 21/001; A63B 71/0036; F26B 9/10; A47B 47/00

(57) ABSTRACT

A sporting equipment drying rack is disclosed herein. The sporting equipment drying rack includes a collapsible structure useful for holding sporting gear, equipment, and other sports accessories. The sporting equipment drying rack is designed to be compact for portability, and may be particularly useful for drying and deodorizing wet and smelly sports equipment after use.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of sports accessories and more specifically relates to sporting gear drying equipment.

### 2. Description of Related Art

Protective pads, helmets, gloves, special footgear, colorful clothing and other apparel and equipment have become more popular (and more expensive) for a variety of sports. Proper care and conditioning of such equipment is important so that the equipment lasts longer and is comfortable and safe to wear. Soccer, hockey, football, lacrosse and even inline skating are examples of sports that typically require protective elbow pads, knee pads, shin pads, gloves, helmets, special footwear, and, in the case of hockey and inline skating, skates, which are frequently made of leather.

Through use, such equipment becomes damp from sweat. When the equipment is used frequently, such as for daily practice and games, unless it is stored and conditioned properly, it does not dry between uses, but stays damp and becomes smelly and unsanitary. This problem is compounded during periods when, for example, the equipment is used for a tournament or training camp, in which it is typically used several times a day, perhaps for several days in a row.

U.S. Pat. No. 9,015,955 to Jean-François Vezina, Pierrot Lebel relates to a Collapsible Drying Container. Lebel describes a container for storing and drying garments or sport equipment, which comprises an external envelope comprising a resistant material; and a ventilation structure through which air can be blown for drying the garments or sports equipment. The Lebel ventilation structure supports the external envelope, and comprises hanging elements for hanging the garments or sports equipment thereon. The ventilation structure is capable of adopting a retracted position and an extended position. When in the extended position, the ventilation structure occupies more space than when in the retracted position.

### BRIEF SUMMARY OF THE INVENTION

In view of the foregoing disadvantages inherent in the known sports accessories art, the present disclosure provides a novel sporting equipment drying rack. The general purpose of the present disclosure, which will be described subsequently in greater detail, is to provide a sporting equipment drying rack may comprise a collapsible structure useful for holding sporting gear and equipment. The sporting equipment drying rack may be compact for portability, and may be particularly useful for drying and deodorizing wet and smelly hockey equipment after use. An exemplary, non-limiting example of sporting equipment may be a set of hockey equipment.

A sporting equipment drying rack is disclosed herein. The sporting equipment drying rack may generally comprise a base frame, a first “C” shaped tubular member, a second “C” shaped tubular member, at least one first tubular post, and at least one second tubular post.

The base frame may be formed by a plurality of tubular frame members that include a front frame member, a first-side frame member, a second-side frame member, and a back frame member. In a preferred embodiment, the base frame is substantially rectangular and comprises a plurality of fittings for removably coupling the first “C” shaped tubular member, the second “C” shaped tubular member, the first tubular post, and the second tubular post. Further, the base frame may comprise an air flow inlet port configured to internally receive a flow of air from an air blower (such as an air blower).

The first “C” shaped tubular member may be removably coupleable to a midpoint of the first-side member of the base frame, to a midpoint of the second-side of the base frame and in perpendicular orientation to a plane formed by the base frame.

The second “C” shaped tubular member may be removably coupleable to the back frame member, in perpendicular orientation to the plane formed by the base frame, and in parallel orientation to a plane formed by the first “C” shaped tubular member.

The first tubular post(s) may be removably coupleable and in perpendicular orientation to the base frame. The second tubular post(s) may be removably coupleable and in perpendicular orientation to the base frame. Further, the second tubular post(s) may be shorter than the first tubular post(s). As may be appreciated, the first tubular post(s) and the second tubular post(s) may comprise a plurality of ventilation holes therein for allowing the ventilation of air.

A method of using the sporting equipment drying rack is also disclosed herein. The method of may comprise the steps of: assembling the sporting equipment drying rack; placing various sporting equipment and/or athletic gear on the sporting equipment drying rack; connecting an air blower to the air flow inlet port; activating the air blower; and drying the sporting equipment and/or athletic gear. An optional step of using fragrance pellets is also suggested for freshening the scent of very smelly sporting gear.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a sporting equipment drying rack, constructed and operative according to the teachings of the present disclosure.

FIG. 1 is a side perspective view of a sporting equipment drying rack during an ‘in-use’ condition, according to an embodiment of the disclosure.

FIG. 2 is a side perspective view of the sporting equipment drying rack of FIG. 1, according to an embodiment of the present disclosure.

FIG. 3 is a side assembling perspective view of the sporting equipment drying rack of FIG. 1, according to an embodiment of the present disclosure.

FIG. 4 is a view of the sporting equipment drying rack comprising a kit, according to an embodiment of the present disclosure.

FIG. 5 is a flow diagram illustrating a method of use for the sporting equipment drying rack, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a sports accessory and more particularly to a sporting equipment drying rack as used to improve the drying of sporting equipment and athletic apparel after use.

Generally, a sporting equipment drying rack may comprise a collapsible structure useful for holding sporting gear and equipment. The sporting equipment drying rack may be compact for portability, and may be particularly useful for drying and deodorizing wet and smelly sporting equipment (such as hockey gear and apparel) after use.

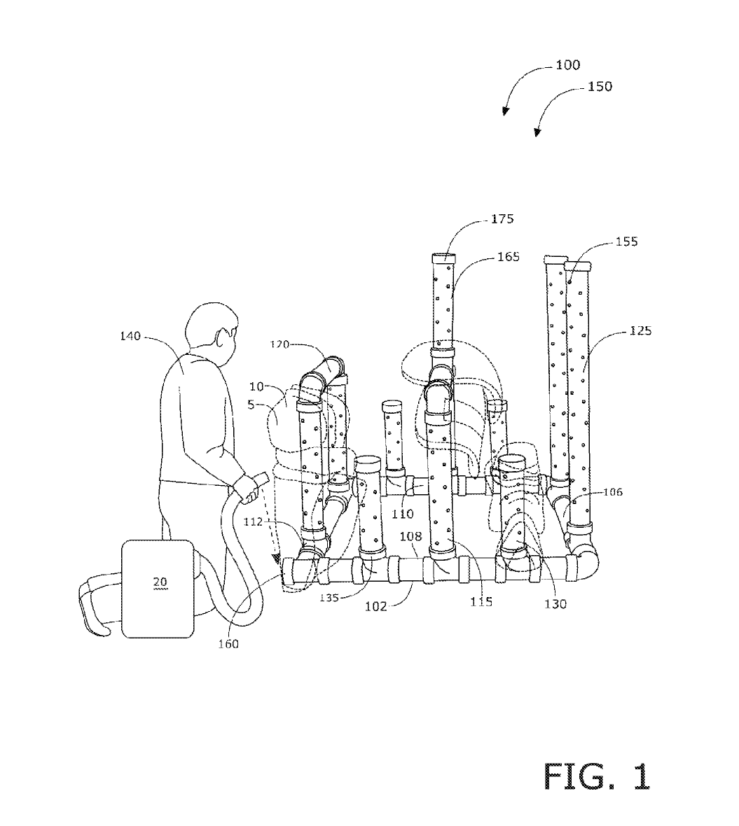

Referring now more specifically to the drawings by numerals of reference, there is shown in FIGS. 1-5, various views of a sporting equipment drying rack 100. FIG. 1 shows a sporting equipment drying rack 100 during an ‘in-use’ condition 150, according to an embodiment of the present disclosure. As Illustrated, the sporting equipment drying rack 100 may include a base frame 102, a first “C” shaped tubular member 115, a second “C” shaped tubular member 120, at least one first tubular post 125, and at least one second tubular post 130.

Furthermore, the base frame 102 may be formed by a plurality of tubular frame members 104 that include a front frame member 106, a first-side frame member 108, a second-side frame member 110, and a back frame member 112. Preferably, the base frame 102 is substantially rectangular and comprises a plurality of fittings 135 for removably coupling the first “C” shaped tubular member 115, the second “C” shaped tubular member 120, the first tubular post 125, and the second tubular post 130. In other embodiments, the base frame 102 may comprise other shapes and dimensions.

Further, the base frame 102 may comprise an air flow inlet port 160 configured to internally receive a flow of air from an air supply 20 (such as an air blower). As shown, the air flow inlet port 160 may be connected to the base frame 102 of the sporting equipment drying rack 100.

The first “C” shaped tubular member 115 may be removably coupleable to a midpoint of the first-side member of the base frame 102, to a midpoint of the second-side of the base frame 102 and in perpendicular orientation to a plane formed by the base frame 102.

The second “C” shaped tubular member 120 may be removably coupleable to the back frame member 112, in perpendicular orientation to the plane formed by the base frame 102, and in parallel orientation to a plane formed by the first “C” shaped tubular member 115.

The first tubular post(s) 125 may be removably coupleable and in perpendicular orientation to the base frame 102. The second tubular post(s) 130 may be removably coupleable and in perpendicular orientation to the base frame 102. Further, the second tubular post(s) 130 may be shorter than the first tubular post(s) 125. As may be appreciated, the first tubular post(s) 125 and the second tubular post(s) 130 may comprise a plurality of ventilation holes 155 therein for allowing the ventilation of air. As may be further seen, a third tubular post 165 may be coupled to the base frame 102 by the first “C” shaped tubular member 115. As shown, the third tubular post 165 may comprise the plurality of ventilation holes 155.

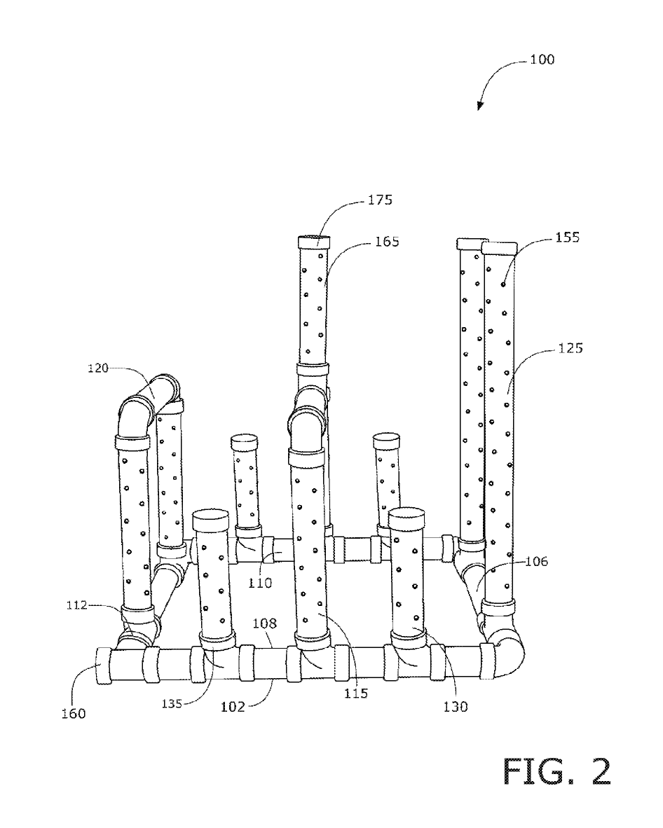

In continuing to refer to FIGS. 1-2, the sporting equipment drying rack 100 may further include a second first-tubular-post and three additional second-tubular-posts. In one embodiment, the first tubular post 125 may comprise a length of approximately 24 inches and the second tubular post 130 may comprise a length of approximately 10 inches. However, it should be appreciated that the first tubular post 125 and the second tubular post 130 may comprise a variety of lengths per user-preference.

As may further be seen, the first tubular post 125 may comprise an end cap 175, the second tubular post 130 may comprise an end cap 175, and the third tubular post 165 may comprise an end cap 175. In such a manner, air may be contained within the hollow volume of the sporting equipment drying rack 100 such that air may only escape through the plurality of ventilation holes 155.

During use, sporting equipment 5 and other athletic apparel is hung on, about, and over the first tubular post 125, the second tubular post 130, the third tubular post 165, the first “C” shaped tubular member 115, and the second “C” shaped tubular member 120 of the sporting equipment drying rack 100. In such a manner, used and sweaty sporting equipment 5 will be spread out and dried by the air supply 20 as directed through the interior hollow volume of the sporting equipment drying rack 100 and out the plurality of ventilation holes 155. In one embodiment, the air flow inlet port 160 may comprise an open tube of a back of the hollow base frame 102 as shown in FIG. 1.

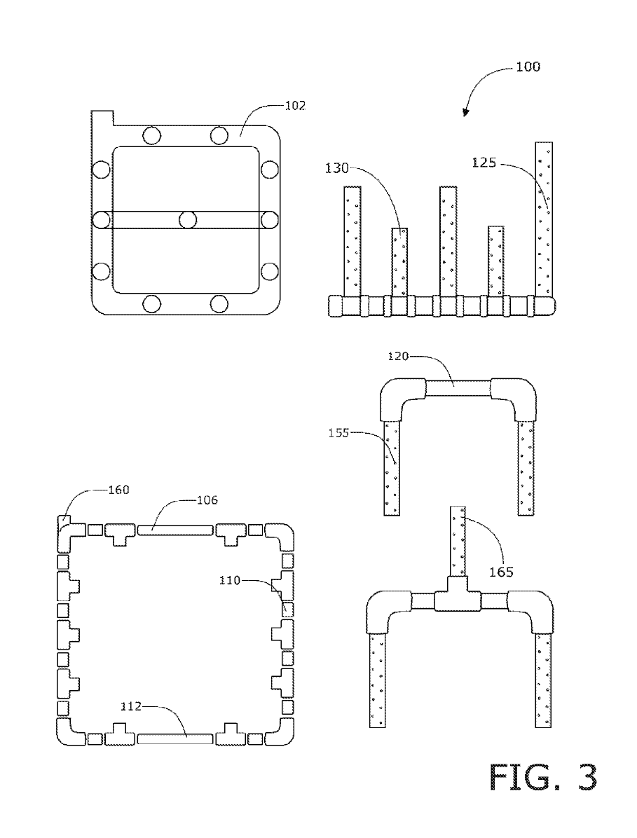

FIG. 3 shows an exploded view of the sporting equipment drying rack 100 of FIG. 1, according to an alternative embodiment of the present disclosure. As shown, the sporting equipment drying rack 100 may comprise: a hollow base frame 102 comprising a front member, a first-side frame member 108, a second-side frame member 110, a back frame member 112, and an air flow inlet port 160; a first “U” shaped member attached to the first-side member, to the second-side frame member 110, and in perpendicular orientation to, a plane formed by the rectangular base frame 102; a second “U” shaped member attached to, and in parallel orientation with, the back frame member 112; at least two posts with a first length that are attached to and in perpendicular orientation to the base frame 102; and at least one post with a second length that is attached to, and in perpendicular orientation with, the base frame 102, such that the first length is shorter than the second length.

In continuing to refer to FIG. 3, the first “U” shaped member, the second “U” shaped member, and the at least two posts with the first length, and at least one post with the second length may comprise a plurality of ventilation holes 155. As may be further seen, the first “U” shaped member, the second “U” shaped member, and the at least two posts with the first length, and at least one post with the second length may each comprise an end cap 175. As may be appreciated, the air flow inlet port 160 of the hollow base frame 102 may be configured to receive an air blower discharge. It should be noted that the air blower discharge may comprise a Shop-Vac.

In one embodiment of the present disclosure, the air flow inlet port 160 may comprise a cavity for retaining fragrance pellets. Fragrance pellets may be useful for adding a freshening scent agent into air flow as generated by the air supply 20 throughout the hollow base frame 102 and through the first “U” shaped member, the second “U” shaped member, and the at least two posts with the first length and second length. The end cap 175 may work to seal the air flow within such that the air flow may only escape through the ventilation holes 155.

In one embodiment of the present disclosure, there may be exactly four posts with the first length and exactly two posts with the second length. The first length may comprise a length of 8 inches and the second length may comprise a length of 24 inches.

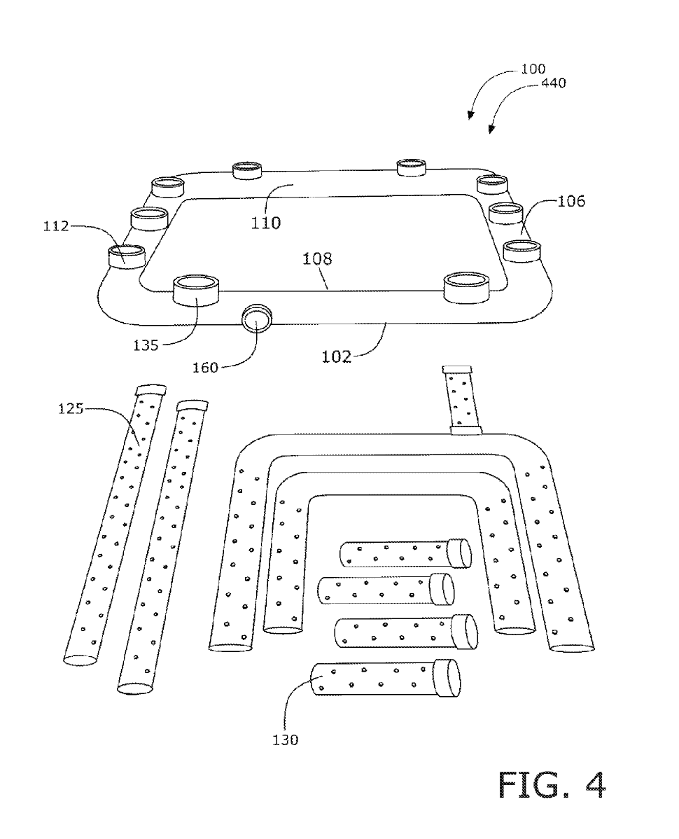

FIG. 4 shows a view of the sporting equipment drying rack 100 of FIG. 1 comprising a kit 440 according to an embodiment of the present disclosure. As above, the kit 440 for the sporting equipment drying rack 100 may include: five tubular members with a first length that are capped on one end, the five tubular members comprising a plurality of ventilation holes 155; two tubular members with a second length that are capped on one end, such that the first length is shorter than the second length, the two tubular members comprising the plurality of ventilation holes 155; two “U” shaped members comprising the plurality of ventilation holes 155; eight tubular connecting members with a third length; two tubular connecting members with a fourth length, wherein the fourth length is longer than the third length; four 90° connecting members; a carrying container sized to contain the unassembled modular drying rack; and a set of instructions for assembly of the drying rack kit 440.

In continuing to refer to FIG. 4, the kit 440 may further comprise a connecting member configured to internally accept the air flow discharge of an air supply 20 for drying sporting equipment 5. As may be appreciated, sporting equipment 5 may comprise gear and sporting accessories for a variety of sports. In a preferred embodiment, the sporting equipment drying rack 100 may be particularly useful for hockey gear 10. However, it is contemplated that the sporting equipment drying rack 100 may be useful for baseball gear, football gear, soccer gear, basketball gear, tennis gear, and the like.

In one embodiment, the base member 102 may comprise a single integrated tubing. In other embodiments, the base member 102 may comprise a plurality of connecting members. For example, the base member may comprise 12 T-connecting members. Other members may be utilized for constructing the base member. In all embodiments, the base member is hollow such that air is able to flow there-through.

In yet another embodiment, the sporting equipment drying rack 100 may comprise the following parts: nine (9) 90 degree elbow members; twelve (12) “T” tubular members; seven (7) end caps; and 21 feet of 1½ tubing. In such a manner, the base member 102 may comprise 28 separate pieces fitted together to form the base member 102.

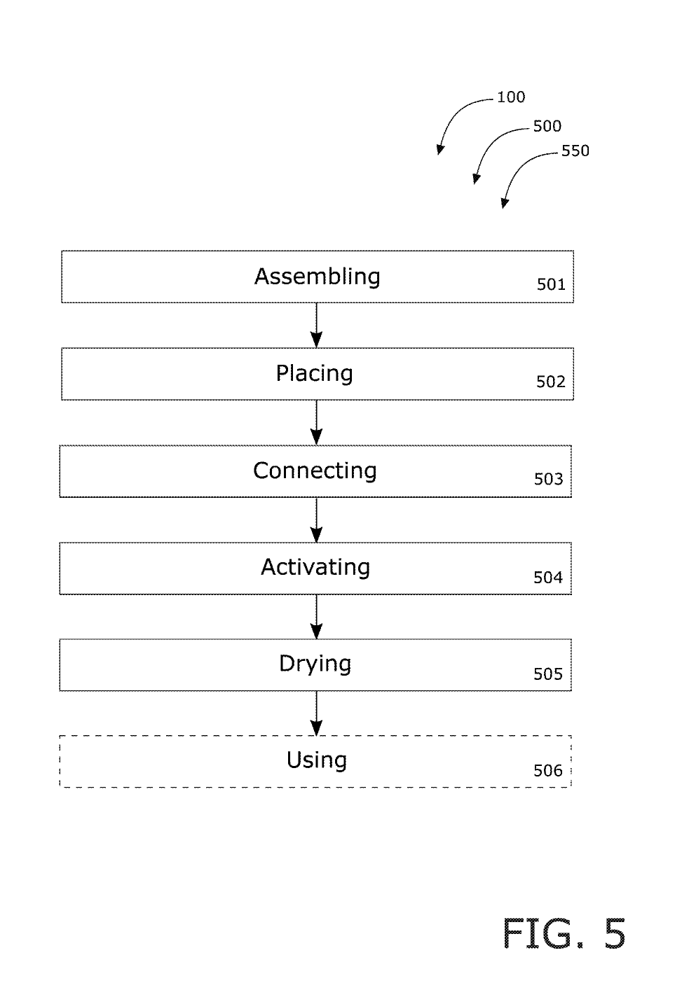

FIG. 5 shows a flow diagram 550 of a method of use 500 of the sporting equipment drying rack 100 of FIG. 1, according to an embodiment of the present disclosure. As above, the sporting the method of use 500 of the sporting equipment drying rack 100 may comprise the steps of: step one 501, assembling the sporting equipment drying rack 100; step two 502, placing various sporting equipment 5 and/or athletic gear on the sporting equipment drying rack 100; step three 503, connecting an air supply 20 to the air flow inlet port 160; step four 504, activating the air supply 20; and step five 505, drying the sporting equipment 5 and/or athletic gear. An optional step six 506 of using fragrance pellets is also suggested for freshening the scent of very smelly sporting equipment 5.

It should be noted that step six 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user 140 preference. The use of “step of” should not be interpreted as “step for”, in the claims herein and is not intended to invoke the provisions of 35 U.S.C. § 112(f). It should also be noted that, under appropriate circumstances, considering such issues as design preference, user 140 preferences, marketing preferences, cost, structural requirements, available materials, technological advances, etc., other methods for sporting equipment drying rack 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A sporting equipment drying rack comprising:
a base frame formed by a plurality of tubular frame members that include a front frame member, a first-side frame member, a second-side frame member, and a back frame member, wherein the base frame is substantially rectangular;
a first “C” shaped tubular member removably coupleable to a midpoint of the first-side member of the base frame, to a midpoint of the second-side of the base frame and in perpendicular orientation to a plane formed by the base frame;
a second “C” shaped tubular member removably coupleable to the back frame member, in perpendicular orientation to the a plane formed by the base frame, and in parallel orientation to a plane formed by the first “C” shaped tubular member;
a first tubular post removably coupleable and in perpendicular orientation to the base frame;
a second tubular post removably coupleable and in perpendicular orientation to the base frame, wherein the second tubular post is shorter than the first tubular post;
wherein the base frame comprises a plurality of fittings for removably coupling the first “C” shaped tubular member, the second “C” shaped tubular member, the first tubular post, and the second tubular post.

2. The sporting equipment drying rack of claim 1, wherein the first tubular post and the second tubular post comprises a plurality of ventilation holes therein.

3. The sporting equipment drying rack of claim 1, wherein the first “C” shaped tubular member and the second “C” shaped tubular member comprises a plurality of ventilation holes therein.

4. The sporting equipment drying rack of claim 1, wherein the base frame comprises an air flow inlet port configured to internally receive a flow of air from an air blower.

5. The sporting equipment drying rack of claim 1 further comprising a third tubular post coupled to the base frame by the first “C” shaped tubular member.

6. The sporting equipment drying rack of claim 5, wherein the third tubular post comprises a plurality of ventilation holes.

7. The sporting equipment drying rack of claim 1, further including a second first-tubular-post and three additional second-tubular-posts

8. The sporting equipment drying rack of claim 1 wherein the first tubular post has a length of approximately 24 inches.

9. The sporting equipment drying rack of claim 1 wherein the second tubular post has a length of approximately 8 inches.

10. The sporting equipment drying rack of claim 1 wherein the first tubular post comprises an end cap.

11. The sporting equipment drying rack of claim 1 wherein the second tubular post comprises an end cap.

12. The sporting equipment drying rack of claim 6 wherein the third tubular post comprises an end cap.

13. A sporting equipment drying rack comprising:
a hollow base frame comprising a front member, a first-side member, a second-side member, a back member, and an air flow inlet port;
a first “U” shaped member attached to the first-side member, to the second-side member, and in perpendicular orientation to, a plane formed by the rectangular base frame;
a second “U” shaped member attached to, and in parallel orientation with, the back frame member;
at least two posts with a first length that are attached to and in perpendicular orientation to the base frame; and
at least one post with a second length that is attached to, and in perpendicular orientation with, the base frame, wherein the first length is shorter than the second length.

14. The sporting equipment drying rack of claim 13, wherein the first “U” shaped member, the second “U” shaped member, and the at least two posts with the first length, and at least one post with the second length comprises a plurality of ventilation holes.

15. The sporting equipment drying rack of claim 14, wherein the first “U” shaped member, the second “U” shaped member, and the at least two posts with the first length, and at least one post with the second length each comprises an end cap.

16. The sporting equipment drying rack of claim 15, wherein the air flow inlet port of the hollow base frame is configured to receive an air blower discharge.

17. The sporting equipment drying rack of claim 16, wherein the air flow inlet port comprises a cavity for retaining fragrance pellets.

18. A drying rack kit product comprising:
five tubular members with a first length that are capped on one end, the five tubular members comprising a plurality of ventilation holes;
two tubular members with a second length that are capped on one end, wherein the first length is shorter than the second length, the two tubular members comprising the plurality of ventilation holes;
two “U” shaped members comprising the plurality of ventilation holes;
eight tubular connecting members with a third length;
two tubular connecting members with a fourth length, wherein the fourth length is longer than the third length;
four 90° connecting members;
a carrying container sized to contain the unassembled modular drying rack; and
a set of instructions for assembly of the drying rack kit.

19. The drying rack kit product of claim 18 including a connecting member configured to internally accept the air flow discharge of an air blower for drying sporting equipment.

20. The drying rack kit product of claim 19 wherein the sporting equipment comprises hockey gear.
